(19) United States
(12) Patent Application Publication
(10) Pub. No.: US 2018/0030239 A1
(43) Pub. Date: Feb. 1, 2018

(54) CRYSTALLINE POLYCARBONATE ARTICLES AND METHODS OF MAKING THE SAME

(71) Applicant: SABIC Global Technologies B.V., Bergen op Zoom (NL)

(72) Inventors: Zahir Bashir, Riyadh (SA); Abdul Salem Thelakkadan, Kerala (IN)

(21) Appl. No.: 15/550,393

(22) PCT Filed: Mar. 21, 2016
(86) PCT No.: PCT/IB2016/051584

§ 371 Date: Aug. 11, 2017

Related U.S. Application Data
(60) Provisional application No. 62/137,353, filed on Mar. 24, 2015.

(51) Int. Cl. C08K 5/098; C08L 69/00; C08J 7/02

(52) U.S. Cl. CPC C08K 5/098; C08J 7/02; C08L 69/00; G01N 25/4866

(57) ABSTRACT

In an embodiment, an article comprises a crystalline polycarbonate, wherein the article has a polycarbonate crystallinity of greater than or equal to 10 wt % based on the total weight of the polycarbonate. In another embodiment, a method of making an article comprises adding a crystalline polycarbonate powder into a cavity of a compression mold; wherein the crystalline polycarbonate powder has a crystallinity of greater than or equal to 10 wt % based on the total weight of the crystalline polycarbonate powder; compressing the crystalline polycarbonate powder in the cavity at a compression temperature of greater than or equal to 10° C. less than the melting temperature of the crystalline polycarbonate powder (T_{comp}≧Tₘ−10° C.) and at a compression pressure of greater than or equal to 1 MPa; and removing the article from the cavity.

### CROSS-REFERENCE TO RELATED APPLICATION

This application claims the benefit of U.S. Provisional Application Ser. No. 62/137,353 filed Mar. 24, 2015. The related application is incorporated herein by reference in its entirety.

### BACKGROUND

Articles formed from polycarbonate generally display high impact strength and high transparency, but lack sufficient solvent resistance, scratch resistance, or mechanical properties, for example, at temperatures above the glass transition temperature of 150 degrees Celsius (° C.), to be used in certain applications. In order to significantly improve one or more of the solvent resistance, the scratch resistance, and the mechanical properties of an amorphous polycarbonate composition, a poly(alkylene terephthalate) (such as poly(ethylene terephthalate) poly(butylene terephthalate)) is generally added. These improved properties have not been observed due to the presence of the polycarbonate itself.

A polycarbonate with improved properties, for example, that is capable of displaying one or both of increased solvent resistance and increased hardness is therefore desired.

### BRIEF DESCRIPTION

Disclosed herein is a crystalline polycarbonate, methods of making, and articles formed therefrom.

In an embodiment, an article comprises a crystalline polycarbonate, wherein the article has a polycarbonate crystallinity of greater than or equal to 10 wt % based on the total weight of the polycarbonate.

In another embodiment, a method of making an article comprises adding a crystalline polycarbonate powder into a cavity of a compression mold; wherein the crystalline polycarbonate powder has an average particle size of 0.5 to 4,000 micrometers and a crystallinity of greater than or equal to 10 wt % based on the total weight of the crystalline polycarbonate powder; compressing the crystalline polycarbonate powder in the cavity at a compression temperature and at a compression pressure for a period of 1 to 30 minutes to form the article, wherein the compression temperature is greater than or equal to 10° C. less than the melting temperature of the crystalline polycarbonate powder (T_{comp}≧Tₘ−10° C.) and wherein the compression pressure is greater than or equal to 1 MPa; and removing the article from the cavity.

The above described and other features are exemplified by the following figures and detailed description.

### BRIEF DESCRIPTION OF THE FIGURES

The following is a brief description of the drawings wherein like elements are numbered alike and which are presented for the purposes of illustrating the exemplary embodiments disclosed herein and not for the purposes of limiting the same.

FIGS. 1-6 are illustrations of an embodiment of a molding device;

FIG. 7 is a graphical illustration of a DSC of the amorphous PC powder of Example 1;

FIG. 8 is a graphical illustration of a DSC of the compression molded amorphous PC powder of Example 1;

FIG. 9 is a graphical illustration of a DSC of acetone-crystallized PC powder of Example 2;

FIG. 10 is a graphical illustration of a DSC of the compression molded crystalline PC powder of Example 2;

FIG. 11 a graphical illustration of a DSC of the billet of Example 2;

FIG. 12 is a photograph of the amorphous billet of Example 6;

FIG. 13 is a photograph of the crystalline billet of Example 6; and

FIG. 14 is a photograph of an injection molded skin core polyethylene article.

### DETAILED DESCRIPTION

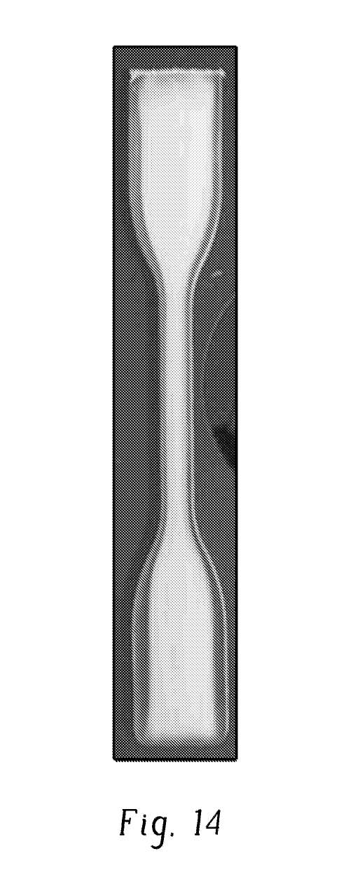

Different polymers show different capacities for achieving crystallinity. For example, some polymers always comprise a crystalline domain whether in powder or pellet form, and are not capable of forming an amorphous article. Examples of such polymers are polyethylene, isotactic polypropylene, and polybutylene terephthalate. Conversely, some polymers are always amorphous, where crystallinity is inhibited, for example, due to steric hindrance of a side chain or an atacticity. Examples of amorphous polymers are atactic polystyrene and poly(methyl methacrylate). A third subset of polymers comprises polymers that can either comprise a crystalline domain or that can be amorphous, for example, depending on the formation conditions of the article, such as polyethylene terephthalate (PET) and polyethylene naphthalate (PEN). Here, it can be difficult to obtain a uniformly crystalline article due to thermodynamic and kinetic limitations. With such polymers a skin core morphology, where the core of the article is crystalline and the skin is amorphous, is often inadvertently formed. The skin core morphology is produced when either the article thickness is too large (for example, greater than 1 mm) and crystallization begins in the middle of the thickness and/or the mold temperature is too high (where, for example, injection molding at a mold temperature of 20° C. results in a skin core crystallized article, see FIG. 14).

Despite the fact that crystalline polycarbonate powder can be obtained, polycarbonate is universally regarded in the industry as an amorphous polymer. As such, conventional injection molding or extrusion processes used for forming a polycarbonate article result in an amorphous polycarbonate article wherein the skin core morphology is not observed. While amorphous polycarbonate articles are commonly used due to their high transparency and impact strength, amorphous polycarbonate articles have limited chemical resistance (for example, when exposed to an acetone vapor such articles are prone to cracking) and are restricted from use in applications above its glass transition temperature, for example, above 150 degrees Celsius (° C.).

Efforts have been made to form crystalline polycarbonate articles, but such articles are difficult to obtain, even under high temperature or high pressure conditions. When exposed to high temperatures, the polycarbonate crystallizes from a melt state where the crystallization is kinetically hindered and can take, for example, hundreds of hours. This long time period is impractical for industrial processes for making articles from a melt crystallized polycarbonate. When exposed to a high pressure, for example, 500 MPa, a hazy region suggestive of crystallinity is only formed in the shear zone, which occurs between the solidified material on the mold wall and the flowing material in the core of the material. (see Handbook of Polycarbonate Science and Technology, John T. Bendler, Marcel Dekker, Inc., New York, N.Y. 2000, Page 300) Therefore, not only does this technique fail to produce a crystalline article as an assumed crystallization is only present in a very thin layer, but the technique is not industrially applicable due to the fact that the high pressure of 500 MPa is too high for most injection molding machines.

Other methods for crystallizing a polycarbonate article involve exposing a polycarbonate article to a solvent such as acetone or to supercritical carbon dioxide. Acetone exposure though results in crystallization of the polycarbonate article near the surface and also results in a pore structure in the article surface that can ultimately result in stress cracking. Exposure of an article to supercritical carbon dioxide also has significant drawbacks as exposure to supercritical carbon dioxide requires high pressure, high heat, and long crystallization times (e.g., occurs on the time scale of hours). For example, treatment of an amorphous polycarbonate sheet with supercritical carbon dioxide at 100° C. and 300 bars takes 12 hours to crystallize and to a crystallinity of only 8 weight percent (wt %) based on the total weight of the polycarbonate.

As described herein, it was surprisingly discovered that a crystalline polycarbonate article could be formed by compression molding a crystalline polycarbonate powder, for example, with a crystallinity of greater than or equal to 10 wt %. It was further surprisingly discovered that the resulting article was capable of achieving one or more of the following: a Vicat softening temperature of greater than or equal to 180° C.; dimensional stability in the range 150 to 210° C. such that an x, y, and z dimension changes by less than or equal to 5%, specifically, less than or equal to 1%; increased solvent resistance to acetone; an increased M value for Rockwell hardness; and improved mold release; where all the comparisons are against an equivalent amorphous polycarbonate article of the same dimensions and with the same composition but without the crystallinity (for example, with a crystallinity of less than or equal to 1 wt %). The article can have a total luminous transmittance of less than or equal to 85%, specifically, less than or equal to 80% as measured in accordance with ASTMD1003-00, Procedure A. The article can have a total luminous transmittance of 0 to 85%, specifically, 0 to 80%, more specifically, 5 to 50%, even more specifically, as measured in accordance with ASTMD1003-00, Procedure A. The article can have a haze of greater than or equal to 5%, as measured using 3.18 or 2.5 mm thick plaques according to ASTM-D1003-00. The article can have a haze of 5 to 80%, specifically, 5 to 50%, more specifically, 10 to 15% as measured using a 1 mm thick plaque according to ASTM-D1003-00.

“Polycarbonate” as used herein means a polymer or copolymer having repeating structural carbonate units of the formula

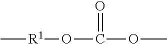

wherein at least 60% of the total number of R¹ groups are aromatic, or each R¹ contains at least one C₆₋₃₀ aromatic group. Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used. The polycarbonate can comprise a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example, aromatic ester units such as resorcinol terephthalate or isophthalate, aromatic-aliphatic ester units based on C₆₋₂₀ aliphatic diacids, polysiloxane units such as polydimethylsiloxane units, or a combination comprising at least one of the foregoing. The polycarbonate can comprise a homopolymer derived from BPA.

Polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example, monocyclic phenols such as phenol, p-cyanophenol, and C₁-C₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example, trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %. Combinations comprising linear polycarbonates and branched polycarbonates can be used.

The polycarbonate can be made by interfacial polymerization, for example, by polymerizing bisphenol A and phosgene process in the presence of a solvent and a catalyst. The polycarbonate can be made by a melt polycondensation, for example, by polymerizing bisphenol A and diphenyl carbonate. The polymerization can comprise a solid state polymerization, for example, to prepare a polycarbonate with an increased molecular weight.

The melt flow rate of the polycarbonate can be less than or equal to 40 grams per 10 minutes (g/10 min), specifically, less than or equal to 10 g/10 min as determined by ASTM D1238-04 at 250° C., 1.5 kilogram (kg). The polycarbonate can comprise a high viscosity polycarbonate and a low viscosity polycarbonate. The low viscosity polycarbonate can have a melt flow rate of greater than or equal to 10 g/10 min, specifically, greater than or equal to 15 g/10 min, more specifically, greater than or equal to 20 g/10 min, measured at 300° C./1.2 kg according to ASTM D1238-04 or ISO 1133. The high viscosity polycarbonate can have a melt flow rate of less than or equal to 8 g/10 min, specifically, less than or equal to 6 g/10 min measured at 300° C./1.2 kg according to ASTM D1238-04 or ISO 1133.

The polycarbonate can have a weight average molecular weight of 10,000 to 200,000 Daltons, specifically, 20,000 to 100,000 Daltons, as measured by gel permeation chromatography (GPC), using a crosslinked styrene-divinylbenzene column and calibrated to polycarbonate references. The polycarbonate can have a weight average molecular weight of 10,000 to 50,000 Daltons, specifically, 10,000 to 30,000 Daltons, as measured by GPC, using a crosslinked styrene-divinylbenzene column and calibrated to polycarbonate references.

The polycarbonate can have an intrinsic viscosity, as determined in chloroform at 25° C., of 0.3 to 1.5 deciliters per gram (dL/g), specifically, 0.45 to 1.0 dL/g.

The crystalline polycarbonate powder is formed by crystallizing a polycarbonate powder, for example, as obtained from an interfacial polymerization process, melt polymerized polycarbonate pellets, or a powder pulverized from a melt polymerized polycarbonate pellet. The crystalline polycarbonate powder can comprise a crystalline polycarbonate polymerized by solid state polymerization. The crystallizing can comprise heating; exposing the polycarbonate powder to a crystallization inducing solvent; exposing the polycarbonate powder to a supercritical CO₂; melt compounding the polycarbonate powder with a chemical nucleating agent to form a composition and pulverizing the composition; or a combination comprising one or more of the foregoing.

The heating can comprise heating the polycarbonate powder to a crystallization temperature, T_{c}, that is greater than the glass transition temperature, T_{g}, of the polycarbonate powder, but lower than its melting temperature, Tₘ, of the crystalline polymer powder. T_{c} can be greater than or equal to Tₘ minus 50° C. and less than Tₘ. For example, the temperature can be 180 to 280° C. The crystallization temperature can be increased as crystallization proceeds, for example, at a rate less than or equal to the rate of increase of the melting temperature. The heating can be at a pressure of less than or equal to 1 atmosphere. The heating can occur for 1 to 200 hours, specifically, 15 to 36 hours.

The heating can comprise heating the polycarbonate powder to a temperature of greater than or equal to 110° C., specifically, 120 to 150° C. The heating can occur in an inert atmosphere with respect to the polycarbonate. The inert atmosphere can comprise nitrogen and/or argon. The rate of crystallization can be altered by altering the flow rate of the inert gas. For example, a nitrogen gas flow of 3 liters per minute (L/min) resulted in a crystallization time of 8 hours, while a flow rate of 6 L/min decreased the crystallization time to 2 hours. When a catalyst is present, it is possible to achieve the crystalline polycarbonate powder in less than or equal to 5 minutes (min).

Solvent crystallization can comprise introducing the polycarbonate powder to a solvent comprising an ether (such as tetrahydrofuran and dioxane), an ester (such as methyl acetate and ethyl acetate), a ketone (such as acetone and methyl ethyl ketone), an aliphatic halogenated hydrocarbon (such as chloromethane, methylene chloride, chloroform, carbon tetrachloride, chloroethane, dichloroethane (position isomers), trichloroethane (position isomers), trichloroethylene, and tetrachloroethane (position isomers)), an aromatic hydrocarbon (such as benzene, chlorobenzene, dichlorobenzene, toluene, and xylene), or a combination comprising one or more of the foregoing. The solvent can comprise acetone, for example, as a mixture with one or both of water and alcohol. The solvent can comprise acetone as it can crystallize the polycarbonate powder without dissolving it. Solvent crystallization can occur at room temperature (for example 23° C.) to a temperature below the boiling point of the solvent. The solvent crystallization temperature can be 20 to 120° C., specifically, 20 to 60° C., more specifically, 23 to 55° C. The solvent crystallization temperature can be 120 to 190° C., specifically, 150 to 180° C. The proportion of solvent can be 1 to 100, specifically, 2 to 50 parts by weight per part of polycarbonate.

Solvent crystallization can comprise introducing the powder to the solvent for less than or equal to 1 minute, specifically, less than or equal to 30 seconds. Solvent crystallization can comprise introducing the polycarbonate powder to the solvent for 5 seconds to 60 minutes, for example, 30 seconds to 5 minutes or 30 minutes to 60 minutes depending on the solvent. After crystallization in the solvent, the crystalline powder can be dried. Solvent crystallization can comprise introducing the powder to acetone for less than or equal to 2 minutes, specifically, less than or equal to 1 minute.

Solvent crystallization can comprise extruding a polycarbonate through micro die holes directly into the solvent in an underwater manner. The extruded polycarbonate is then cut, for example, with a rotary blade into the powder to form the crystalline polycarbonate powder.

Crystallization can comprise crystallizing the polycarbonate powder in the presence of supercritical carbon dioxide, where supercritical carbon dioxide refers to carbon dioxide that is above its critical point. For example, the polycarbonate powder can be introduced to supercritical carbon dioxide at a temperature of 70 to 190° C., specifically, 100 to 180° C.; at a pressure of 120 to 350 bar; for 1 to 30 hours, specifically, 8 to 24 hours.

Crystallization can be enhanced, for example, by the introduction of a nucleating agent such as a clay (such as montmorillonite), a trimellitic acid tridecyloctyl esters, organic salts like sodium salt of o-cholorobenzoate or sodium salt of o-chlorophenate, or a combination comprising one or more of the foregoing.

Crystallization can occur in the presence of a catalyst, for example, at a temperature of 180 to 280° C. The catalyst can comprise an alkali metal bisphenol salt, an alkali metal borohydride, a bioxyanion carboxylate, a bioxyanion phenolate, or a combination comprising one or more of the foregoing. The catalyst can comprise an alkali metal hydroxide (such as NaOH), an alkali metal alkoxide, a tetraalkylammonium compound (such as a hydroxide, alkoxide, or carboxylate), a tetraalkylphosphonium compound (such as a hydroxide, alkoxide or carboxylate), or a combination comprising one or more of the foregoing. The alkyl groups can be C₁₋₈ alkyl groups such as methyl n-butyl, n-hexyl or 2-ethylhexyl, with methyl generally being preferred. The proportion of catalyst can be 10 to 200 parts per million by weight (ppm) of the polycarbonate.

Examples of alkali metal hydroxides include sodium hydroxide and potassium hydroxide, for example, in an amount of less than or equal to 5 ppm based on the weight of the polycarbonate. Examples of alkoxides include C₁₋₈ alkoxides, specifically, methoxides. Further examples of alkoxides include alkoxides of polyhydroxy compounds such as ethylene glycol. Examples of carboxylates include the tetraalkylammonium and-phosphonium hydrogen mono- and polycarboxylates, for example, dicarboxylates including succinates, maleates, glutarates and adipates. Examples of carboxylates include bis(tetraalkylammonium-phosphonium) dicarboxylates, tetraalkylammonium-phosphonium hydrogen dicarboxylates, and tetraalkylammonium maleates.

The crystalline polycarbonate powder can be separated from the solvent by using a centrifugal separator, vacuum-drying, dehumidification-drying, hot-air drying, or a combination comprising one or more of the foregoing. For example, the crystalline polycarbonate powder can be heated to a temperature of 130 to 200° C. for example, for 1 to 5 hours. The crystalline polycarbonate powder can comprise less than or equal to 60 ppm of water, specifically, less than or equal to 50 ppm of water.

The crystalline polycarbonate powder can have a crystallinity of greater than or equal to 10 wt %, specifically, greater than or equal to 20 wt %, more specifically, 20 to 45 wt % based on the total weight of the crystalline polycarbonate powder, i.e., the crystalline portion and the amorphous portion. The crystalline polycarbonate powder can have a crystallinity of 10 to 25 wt % based on the total weight of the crystalline polycarbonate powder. The crystalline polycarbonate powder can have a crystallinity of 10 to 60 wt % based on the total weight of the crystalline polycarbonate powder and a melting temperature of up to 300° C., for example, when crystallized in the presence of an organic salt comprising one or both of a sodium salt of o-chlorobenzoate and a sodium salt o-chlorophenate.

Crystallinity can be determined, for example, by differential scanning calorimetry, by wide angle x-ray diffraction, or by density measurements. For example, in x-ray diffraction, the crystalline polycarbonate powder can be irradiated with an x-ray and scattering of the x-rays can be used to determine the percent crystallinity. Here, the total intensity of the scattered x-rays is a sum of the x-ray intensity of the crystalline scattering ascribed to the crystalline portion and intensity of the amorphous scattering ascribed to the amorphous portion. The weight of the crystalline portion and the amorphous portion can be expressed as M_{c} and Mₐ, respectively, and the x-ray intensity of the crystalline scattering corresponding to the weight of the crystalline portion and amorphous scattering corresponding to the weight of the amorphous portion are expressed as I_{c} and Iₐ, respectively. The crystallinity, X_{c} (wt %) can be calculated from the following equations:

$${X}_{c} = \frac{{M}_{c}}{{M}_{c} + {M}_{a}} \times 100 = \frac{{I}_{c}}{{I}_{c} + {KI}_{a}} \times 100$$

wherein K is defined as I_{100c}/I₁₀₀ₐ and I_{100c} is the x-ray intensity of a crystalline scattering per unit weight of the one hundred percent crystalline portion and I₁₀₀ₐ is the x-ray intensity of the one hundred percent amorphous portion.

The crystalline polycarbonate powder comprises a plurality of particles. The particles can be any shape, for example, spherical, cylindrical, ovoid, polygonal, disk, pellets, fibrous, irregular, etc. The polycarbonate powder can comprise a melt polycarbonate powder in the form of pellets obtained from a melt polycarbonate reaction. The polycarbonate powder can comprise an interfacial polycarbonate powder obtained from an interfacial polycarbonate reaction. The particles can have an average longest dimension (for example, an average diameter for spherical particles or an average fiber length for fibers) of 500 nanometers to 4,000 micrometers. The particles can have an average particle size of 500 nanometers to 4,000 micrometers, where the particle size can refer to the longest dimension of the particle. The crystalline polycarbonate powder can comprise a bimodal particle size distribution. The average particle size can be determined by averaging the diameter from at least 10 particles imaged by a scanning electron microscope. The average particle size of particles, for example, with a particle size of less than or equal to 10 micrometers can be determined using a dynamic light scattering particle size analyzer, for example, using a Zetasizer as commercially available by Malvern Instruments Ltd., Worcester, UK and averaging the longest dimension of, for example, greater than 15,000 particles.

The crystalline powder can have a core-shell morphology, where the core has an amorphous polycarbonate and the shell has a crystalline morphology. Such a morphology can be obtained using solvent crystallization and is unique to polycarbonates, as other polymers, such as poly(ethylene terephthalate), were not found to be capable of forming such morphologies. The relative amount of the core domain to the shell domain can be modified, for example, by changing one or more of the particles, the solvent concentration, and the exposure time to the solvent. Mixtures of different core-shell morphologies can be used. The crystalline polycarbonate powder can comprise one or more crystalline polycarbonate powders. For example, a crystalline polycarbonate powder with a crystallinity of 5 to 12 wt % and a second crystalline polycarbonate powder with a crystallinity of 13 to 20 wt %. It is believed that using such a core shell morphology will result in a further increase in the impact properties of the crystalline article compression molded from these core shell particles.

Unfortunately, typical methods of forming polycarbonate articles were not successful in forming a crystalline polycarbonate article and only used amorphous polycarbonate. For example, injection molding injects a molten polycarbonate into a mold, hence melting the crystalline polycarbonate and losing the crystalline structure. Similarly, cold compression followed by pressureless diffusion welding and heating was not successful in consolidating the crystalline polycarbonate powder and resulted in porous polycarbonate compositions.

It was surprisingly discovered that an article can be formed by compressing a crystalline polycarbonate powder at a compression temperature while maintaining a crystallinity of greater than or equal to 10 wt %, specifically, greater than or equal to 20 wt %, more specifically, 20 to 45 wt % based on the total weight of the crystalline polycarbonate powder, i.e., the crystalline portion and the amorphous portion. The crystalline polycarbonate powder can have a crystallinity of 10 to 25 wt % based on the total weight of the crystalline polycarbonate powder. The crystalline polycarbonate powder can have a crystallinity of 10 to 60 wt % based on the total weight of the crystalline polycarbonate powder. The average length of a longest dimension of the crystalline domains can be 5 to 500 micrometers, specifically, 10 to 100 micrometers.

Specifically, the crystalline polycarbonate article can be formed by compression molding the crystalline polycarbonate powder in a compression mold with an applied heat. The compression temperature, T_{comp}, can be greater than or equal to 10° C., specifically, 10 to 20° C. less than the melting temperature, Tₘ, of the crystalline polycarbonate powder (for example, Tₘ>T_{comp}≧Tₘ−10° C.). The compression temperature can be 190 to 290° C., specifically, 200 to 260° C., more specifically, 230 to 255° C. The compression temperature can be 200 to 220° C.

Due to the crystallinity of the formed article, it was surprisingly discovered that the mold temperature could be elevated as compared to the typical mold temperatures used in compression molding of amorphous polycarbonate and did not have to be reduced prior to removal of the crystalline article from the mold. As compared to compression molding of amorphous polycarbonate, if the mold temperature is too high, then the mold release of the article will not be clean and residual material will remain present in the mold. Here, prior to adding the amorphous polycarbonate powder to the mold, the mold can be preheated to a preheat temperature, Tₚ, of greater than or equal to 100° C., specifically, greater than or equal to 50° C. below the compression temperature or it can be heated to the compression temperature (for example, T_{comp}≧Tₚ≧T_{comp}−50° C.). Further, the release temperature, Tᵣ, can be greater than or equal to 150° C., specifically, greater than or equal to 50° C. below the compression temperature or it can be heated to the compression temperature (for example, T_{comp}≧Tᵣ≧T_{comp}−50° C.). The release temperature, Tᵣ, can be greater than or equal to 10° C., specifically, 10 to 20° C. less than the melting temperature, Tₘ, of the crystalline polycarbonate powder (Tᵣ≧Tₘ−10° C.). The release temperature can be 160 to 255° C., specifically, 160 to 220° C. or 230 to 255° C. The preheat temperature can be within 10° C. of the release temperature (Tₚ=T_{c}±10° C.), for example, it can be the same as the release temperature. The release temperature, Tᵣ, can be greater than or equal to the glass transition temperature of the polymer (Tᵣ≧T_{g}).

It was surprisingly discovered that good mold release (i.e., without the article sticking to the mold), was attained at a PC crystallinity of only 10 wt %. Therefore, the crystalline polycarbonate can have a crystallinity of greater than or equal to 10 wt %, specifically, 10 to 50 wt %, more specifically, 10 to 20 wt % or 20 to 25 wt %.

The method for preparing the article comprising the crystalline polycarbonate can comprise adding a crystalline polycarbonate powder to a cavity of a compression mold; wherein the crystalline polycarbonate powder has an average particle size of 0.5 to 4,000 micrometers and a crystallinity of greater than or equal to 10 wt % and compressing the crystalline polycarbonate powder in the mold to form the article, and removing the article from the mold. The compression can occur for 1 to 30 minutes. The compression can occur at a compression temperature that is greater than or equal to 10° C. less than the melting peak of the crystalline polycarbonate powder. The compression can occur at a compression pressure of greater than or equal to 1 MPa, or 1 to 50 MPa. The compression mold can apply pressure to one or both sides of the polycarbonate powder.

In order to minimize a pressure gradient during the compression, the aspect ratio of a mold dimension perpendicular to the mold surface, to a mold dimension parallel to the mold surface can be less than or equal to 10:1, specifically, less than or equal to 5:1, for example, 3:1 to 5:1.

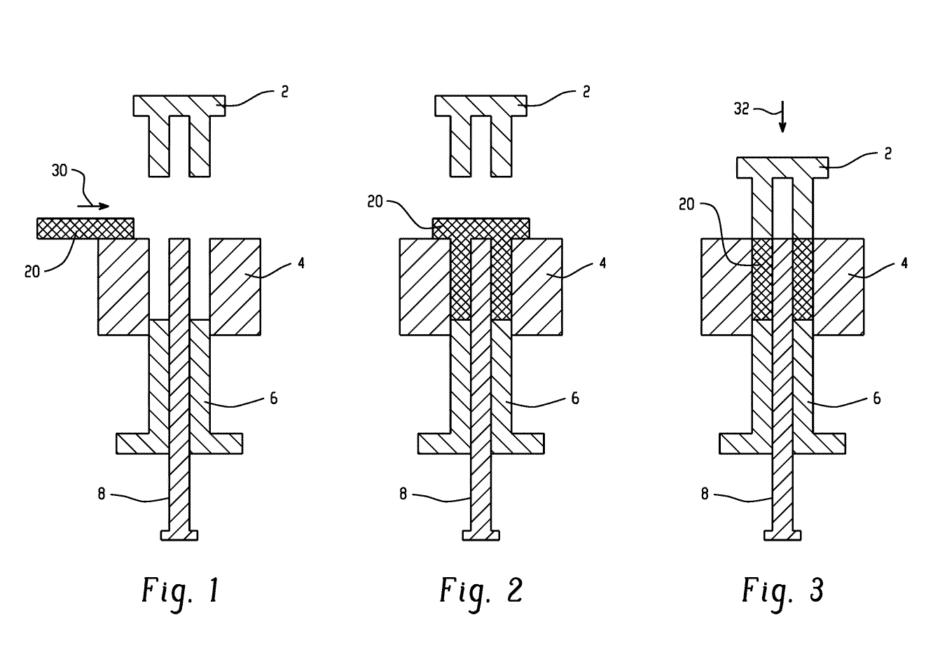

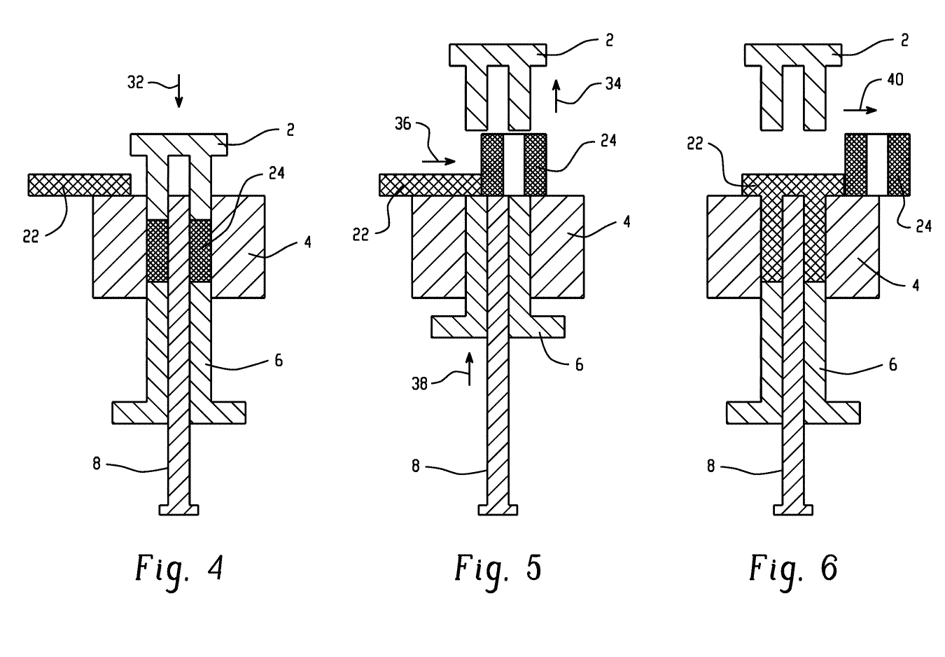

An example of a compression mold for forming a cylindrical article is illustrated in FIGS. 1-6. Specifically, crystalline polycarbonate powder 20 is added to a cavity in mold 4 in direction 30. Insert 8 can be present if a hollow tube is desired. Mold top portion 2 can press in direction 32 on crystalline polycarbonate powder 20 to form article 24. Excess crystalline polycarbonate powder 20 can be removed prior to pressing mold top portion 2. After formation of article 24, mold top portion 2 can be withdrawn in direction 34 and mold portion 6 can be pressed in direction 38 to push the article 24 out of the mold 4. After article 24 is removed from the mold 4 in direction 40, second crystalline polycarbonate powder 22 can be added to the cavity and the process can be repeated.

The process of making the article can be performed in an inert atmosphere, for example, under nitrogen, specifically, under dry nitrogen comprising less than or equal to 5 volume percent (vol %) water. The process of making the article can be performed such that a vacuum is applied to the cavity of the die prior to adding the crystalline polycarbonate powder. The vacuum can be 10 to 1,000 millibars (mbar), specifically, 10 to 500 mbar, more specifically, 50 to 200 mbar. The vacuum can help prevent macro-voids formation in the article due to trapped air.

The mold, for example, a mold top portion and a mold bottom portion can be heated and cooled, for example, by incorporation of a heating and cooling system located in one or both of the top and bottom mold portions. The system can comprise an oil heating system or an electrical heating system.

The article can have a crystallinity of greater than or equal to 10 wt % and can have one or more of the following: a Vicat softening temperature of greater than or equal to 180° C.; dimensional stability in the range 150 to 210° C. such that an x, y, and z dimension changes by less than or equal to 5%, specifically, less than or equal to 1%; increased solvent resistance to acetone; an increased M value for Rockwell hardness; and improved mold release; where all the comparisons are against an equivalent amorphous polycarbonate article of the same dimensions and with the same composition but without the crystallinity. A Vicat softening temperature of greater than or equal to 180° C. can mean that the softening is not dominated by the amorphous component with T_{g} of, for example, 150° C. A polycarbonate article with such remarkable properties has not been produced by extrusion or injection molding processes.

A melt flow rate of the crystalline article can be less than or equal to 40 grams per 10 minutes (g/10 min), specifically, less than or equal to 10 g/10 min as determined by ASTM D1238-04 at 250° C., 1.2 kg.

The crystalline article as used herein is not the crystalline polycarbonate powder (for example, with an average particle size of 1 to 1,000 micrometers), an extruded crystalline polycarbonate pellet (for example, with a length scale on the order of a few millimeters), or a crystalline polycarbonate fiber (for example, with an average diameter of less than or equal to 20 micrometers). For example, the article can have a length scale that is not a fiber length that is 0.05 millimeters (mm) to 10 centimeters (cm). The length scale can be a wall thickness, for example, of a sheet, a cylinder, a tube, or of a more complex article such as a gear thickness. The article can have a shortest dimension of greater than or equal to 0.2 millimeters. The article can have an aspect ratio of a shortest dimension to a longest dimension of greater than or equal to 1:1, specifically, greater than or equal to 1:10, more specifically, greater than or equal to 1:100.

The compression mold can form an article of any shape, for example, a sheet (flat or curved, such as a tile or a panel), a cylinder (for example, a solid cylinder or a hollow cylinder), and the like. When the compression mold forms a sheet, the mold can comprise a top mold surface and a bottom mold surface that are flat. For making a gear, one of the mold portions will be a cylindrical tool with the teeth of the gear cut along its circumference, and other mold portion will have the teeth of the gear cut into the entire length of the barrel. The article can be, for example, a gear, a cam, a porous filter, a flat tile, a bracket, a grill, a panel (for example, a flat panel or a curved panel), a bearing, a bush, a bearing cap, a rotor, a sprocket, a thrust plate, a pulley (for example, a timing pulley), a synchronizer hub, or a piston ring. The article can be a fuel injection component, a shock absorber component, or a valve train component. The article can be a casing (for example, of a laptop, a tablet, a smart phone, and the like). The article can have had a maximum dimension of 1 centimeter to 5 meters, specifically, 1 centimeter to 3 meters, for example, 1 centimeter to 1 meter or 1 to 50 centimeters. The article can have a minimum dimension of 0.2 millimeter to 50 centimeters, specifically, 1 millimeter to 25 centimeters.

The following examples are provided to illustrate the crystalline polycarbonate article. The examples are merely illustrative and are not intended to limit devices made in accordance with the disclosure to the materials, conditions, or process parameters set forth therein.

### EXAMPLES

PC1 powder (PC9175, commercially available from SABIC's Innovative Plastics Business) was used in the examples below. The PC1 powder is an interfacial polycarbonate, with a weight average molecular weight of 21,800 daltons based on polycarbonate standards, an intrinsic viscosity of 47 milliliters per gram (mL/g), a melt volume flow rate (MVR) of 29.6 centimeters cubed per 10 minutes (cm³/10 min) at 300° C. and 1.2 kg, a density of 180 kilograms per meters cubed (kg/m³), and a T_{g} of 143° C. The particle size sieve fractions of the PC1 powder were: 0.1 wt % had a diameter of greater than 4.75 mm; 0.3 wt % had a diameter of greater than 4.0 mm; 2.5 wt % had a diameter of greater than 2.8 mm; and 10 wt % had a diameter of greater than 2.0 mm; and the average particle size distribution was 0.5 to 4,000 micrometers.

Differential Scanning calorimetry (DSC) data was obtained using a Universal V4.5 TA Instrument.

Vicat softening temperature was determined using a 3 mm thick compression molded sheet using the Vicat A test. In the Vicat A test, a load of 10 newton (N) is applied to a flat, circular probe with a 1 millimeters squared (mm²) area on the sample while heating the sample at 50° C./hour by immersing in an oil bath. The softening temperature is the temperature at which the probe penetrates the specimen by a depth of 1 mm.

Rockwell hardness was determined using the M scale by applying a load on a flat sheet with a steel ball with a diameter of 6.35 mm by first applying a load of 98 N for 15 seconds; increasing the load to 980 N for 15 seconds; and decreasing the load back to 98 N for 15 seconds. The indentation depth is then measured and the M scale Rockwell hardness determined.

### Example 1: The Amorphous PC Powder and Preparation of Amorphous PC Articles

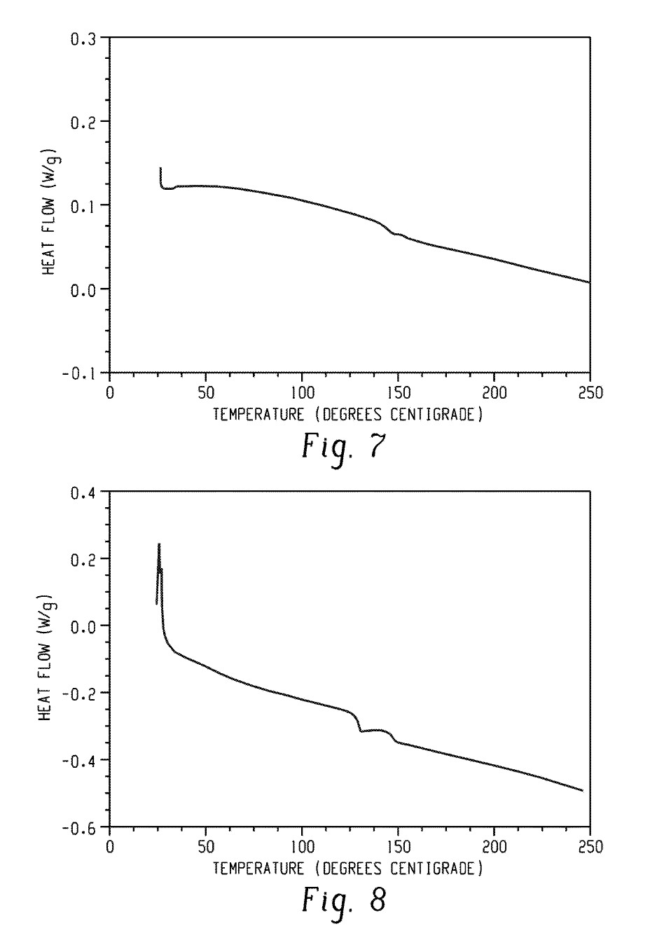

The DSC of amorphous powder is shown in FIG. 7 confirming the amorphous characteristic of the polymer powder. The DSC shows a step-like change in the T_{g} at about 143° C. and no indication of a first order melting peak.

An amorphous sheet and an amorphous billet were made from amorphous PC1 using a powder compression process. The sheet was formed by compression molding the amorphous PC1 powder in an Agila Machine (100 T, Max operating pressure of 20.5 MPa and max operating temperature of 300° C.) at a temperature of 210° C. and at a pressure of 5 MPa for 10 min. The amorphous billet with a diameter of 15 mm and a length of 50 mm was prepared by compressing the amorphous powder in a capillary rheometer (CEAST 5000; barrel diameter 15 mm and barrel length 50 mm) at a temperature of 210° C. and at a pressure of 50 MPa for 15 minutes. The die was blocked to prevent extrusion of the PC1 as a melt. The billet was cooled to 145° C. (below the T_{g}) and ejected from the rheometer. The amorphous sheet and the amorphous billet were transparent and had a total luminous transmittance of 81 to 90% as measured in accordance with ASTMD1003-00, Procedure A.

A DSC of the amorphous sheet was taken and is shown in FIG. 8. FIG. 8 shows that the softening temperature is about 150° C., which corresponds to the T_{g} for the amorphous polycarbonate. The Vicat softening temperature of the amorphous sheet was determined to be about 150° C.

### Example 2: Crystalline PC Powder and Preparation of Crystalline PC Articles

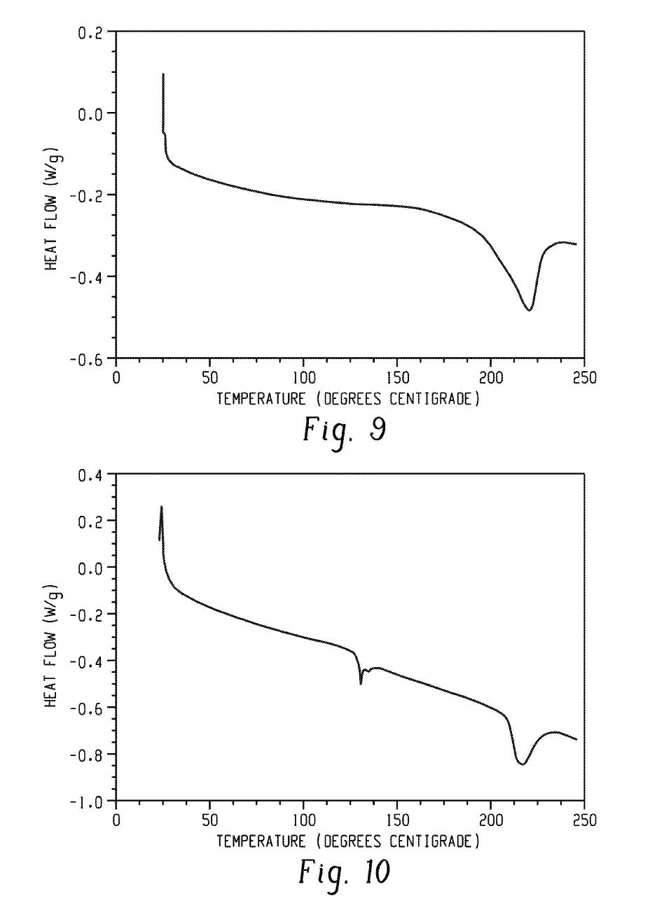

Amorphous PC1 powder was crystallized in acetone by immersing the powder in acetone for 1 minute to form a crystalline powder. The crystalline powder was then filtered and dried at room temperature. The DSC of crystalline powder is shown in FIG. 9 confirming the crystalline characteristic of the polymer powder.

From the DSC trace of FIG. 9, the T_{g} of the acetone-treated PC powder was determined to be 144° C. and the melting peak with heat of fusion was determined to be 24.82 Joules per gram (J/g). Using a heat of fusion of ΔH=109.8 J/g for 100 wt % crystalline PC (X. Hu and A. J. Lesser, Polymer 45, 2333 (2004)), the degree of crystallinity of the powder after acetone treatment was estimated to be about 22.6 wt %.

The crystalline sheet was formed by compression molding the crystalline PC1 powder in an Agila Machine (100 T, Max operating pressure of 20.5 megaPascal (MPa) and max operating temperature of 300° C.) at a temperature of 210° C. and at a pressure of 20 MPa for 10 min. A crystalline billet with a diameter of 15 mm and a length of 50 mm was prepared by compressing the crystalline powder in a capillary rheometer (CEAST 5000; barrel diameter 15 mm and barrel length 50 mm) at a temperature of the crystalline powder of 210° C. and at a pressure of 50 MPa for 15 minutes. The billet was cooled to 170° C. and ejected from the rheometer. The sheet and the billet were cloudy due to the crystalline nature of the polycarbonate.

A DSC of the crystalline sheet was taken and is shown in FIG. 10. A DSC of the crystalline billet was taken and is shown in FIG. 11. The DSC data shows a crystalline melting peak with a heat of fusion of 17.9 J/g indicating that the part was semi-crystalline. The density of the compacted billet made from the crystalline powder was measured using a Densimeter-H (model D-H100) according to ASTM D 792-13 and was found to be 1,210 kg/m³, which is greater than the density of amorphous polycarbonate article made by injection molding of 1,1974 kg/m³. The Vicat softening temperature of the crystalline sheet was determined to be at least 180° C., where it is noted that the temperature determinate was limited to 180° C. due to the heating limit of the maximum temperature apparatus' heating oil. It is noted that this Vicat softening temperature is at least 30° C. higher than that of the amorphous PC sheet. The billet was non-porous.

The 3 mm thick semi-crystalline sheet was cut in 2 cm×2 cm with scissors. Unexpectedly, crystallisation had not made the sheet brittle as it was difficult to cut the sheet and it did not lead to chipping or sudden snapping.

### Example 3: Solvent Resistance to Dichloromethane

Solvent resistance to dichloromethane, which is considered to be a strong solvent for amorphous polycarbonate at room temperature, was determined by measuring the time to complete dissolution of discs taken from the billets and sheets of Examples 1 and 2. The discs cut from the cylinders had a height of 3 mm and a diameter of 15 mm. The sheets were 20 mm by 17.5 mm by 1.5 mm. The samples were placed in separate 100 mL round bottom flasks and 50 mL of dichloromethane was added to each of the flasks. The solutions were stirred with a magnetic stirrer at 530 revolutions per minute (rpm). The dissolution was measured at a temperature of 30° C.

TABLE 2

| | | |
|---|---|---|
| Example | 1 | 2 |

Resistance to dichloromethane

| | | |
|---|---|---|
| Disc, time to complete | 35 | 68 |
| dissolution (min) | | |
| Sheet, time to complete | 18.6 | 28 |
| dissolution (min) | | |
| Sheet immersed in acetone | Whitening, | No change |
| | pore etching, | in the sample |
| | and brittle failure | was observed |

Table 2 shows that the crystalline samples were more resistant to dichloromethane than the amorphous samples.

### Example 4: Solvent Resistance to Acetone

20 mm by 20 mm samples of the amorphous and crystalline sheets of Examples 1 and 2 were immersed in acetone. Immersion of the amorphous sheet in acetone resulted in sample whitening and etching of pores and channels into the surfaces. The sheet further displayed dimensional instability and deformation due to the acetone immersion. Applying pressure with a sharp blade led to brittle fracture of the sample.

Surprisingly, and in contrast to the amorphous sheet, no further whitening or pore etching was observed due to immersion of the crystalline sheet in acetone. Further, applying pressure with a sharp blade to the immersed crystalline sheet did not result in brittle failure, showing the increased toughness of the crystalline sheet as compared with the amorphous sheet.

### Example 5: Rockwell Hardness

The Rockwell hardness M values for various thermoplastic sheets were measured and are shown in Table 3. The amorphous polycarbonate sheet was formed using the amorphous powder of Example 1 and the crystalline polycarbonate sheet was formed using the crystalline powder of Example 2.

TABLE 3

| Polymer Sheet | M | Process |
|---|---|---|
| High density polyethylene | 32 | Injection molded |
| Amorphous polycarbonate | 33.3 | Injection molded |
| Amorphous polycarbonate | 26.2 | Compression molded |
| Crystalline polycarbonate | 63.3 | Compression molded |
| (20 wt % crystallinity) | | |
| Polystyrene | 53 | Injection molded |
| High impact polystyrene | 71 | Injection molded |
| Amorphous poly(ethylene terephthalate) | 68.7 | Injection molded |
| Crystalline poly(ethylene terephthalate) | 78 | Compression molded |
| (50 wt % crystallinity) | | |

Table 3 illustrates that the crystalline polycarbonate sheet had an increase of more than 100% as compared with the amorphous polycarbonate sheet using the same formation method and had a 90% increase over the M value of the injection molded amorphous polycarbonate. This increase is particularly surprising considering that the compression molded crystalline poly(ethylene terephthalate) with a high crystallinity of 50 wt % only resulted in a 13% increase in M value over the injection molded amorphous poly(ethylene terephthalate). Further, the Rockwell M hardness value of the crystalline polycarbonate sheet was greater than the M hardness values of the high density polyethylene sheet and the polystyrene sheets. These results were surprising and could not have been anticipated.

### Example 6: Billet Release Temperature

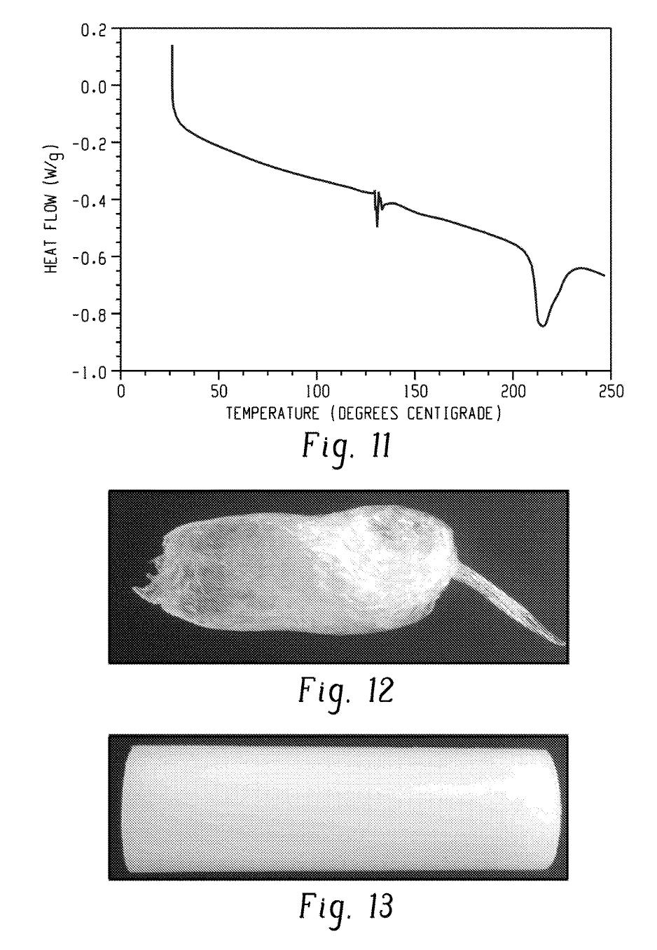

The release ability at a release temperature of 210° C. of an article compressed from an amorphous polycarbonate powder and an article compressed from a 10 to 20 wt % crystalline polycarbonate powder was measured. FIG. 12 is a photograph of the released amorphous article and FIG. 13 is a photograph of the released crystalline article. FIG. 12 clearly shows that the release of the amorphous article at a temperature above the T_{g} of the polymer resulted in a significantly deformed article. Surprisingly, FIG. 13 shows that the crystalline article with a crystallinity of only 10 to 20 wt % was capable of being ejected from the mold at the increased temperature of 210° C. and that is well above the T_{g} of the polymer. The good release of the crystalline article is surprising because the amorphous fraction is the dominant phase and one would have expected sticking, especially due to the compression pressure. This finding is important in manufacturing as it means the parts can be discharged without or with minimal cooling and reheating the cavity that would ultimately result in an increased cycle time.

Set forth below are some embodiments of the present article and methods of making the same.

### Embodiment 1

An article comprising a crystalline polycarbonate, wherein the article has a polycarbonate crystallinity of greater than or equal to 10 wt % based on the total weight of the polycarbonate. The article can be made by the method of any of Embodiments 6-21.

### Embodiment 2

The article of Embodiment 1, wherein the crystalline polycarbonate has one or more of: a heat of fusion of greater than or equal to 5 J/g, a melting peak of greater than or equal to 205° C., a Vicat softening temperature of greater than or equal to 160° C. or greater than or equal to 180° C.; a dimensional stability in the range 150 to 210° C. such that an x, y, and z dimension changes by less than or equal to 5%, specifically, less than or equal to 1%; and increased solvent resistance to acetone; and an improved mold release; where all the comparisons are against an equivalent amorphous polycarbonate article of the same dimensions and with the same composition, but with a crystallinity of less than or equal to 1 wt %.

### Embodiment 3

The article of any of the preceding embodiments, wherein the article has a shortest dimension of greater than or equal to 0.2 millimeters.

### Embodiment 4

The article of any of the preceding embodiments, wherein the article has an aspect ratio of a shortest dimension to a longest dimension of greater than or equal to 1:1 or greater than or equal to 1:10.

### Embodiment 5

The article of any of the preceding embodiments, wherein the article has an increased M value, for example, having a greater than 90% increase for Rockwell hardness as compared to an equivalent amorphous polycarbonate article of the same dimensions and with the same composition, but without the crystallinity.

### Embodiment 6

A method of making the article of any of Embodiments 1-5, comprising: adding a crystalline polycarbonate powder into a cavity of a compression mold; wherein the crystalline polycarbonate powder has an average particle size of 0.5 to 4,000 micrometers and a crystallinity of greater than or equal to 10 wt % based on the total weight of the crystalline polycarbonate powder; compressing the crystalline polycarbonate powder in the cavity at a compression temperature and at a compression pressure for a period of 1 to 30 minutes to form the article, wherein the compression temperature is greater than or equal to 10° C. less than the melting temperature of the crystalline polycarbonate powder (T_{comp}≧Tₘ−10° C.) and wherein the compression pressure is greater than or equal to 1 MPa; and removing the article from the cavity.

### Embodiment 7

The method of Embodiment 6, further comprising crystallizing an amorphous polycarbonate powder to form the crystalline polycarbonate powder; and drying the crystalline polycarbonate powder.

### Embodiment 8

The method of Embodiment 7, wherein crystallizing comprises heating and/or exposing the amorphous polycarbonate powder to a crystallization inducing solvent.

### Embodiment 9

The method of Embodiment 8, wherein the solvent comprises acetone.

### Embodiment 10

The method of any of Embodiments 8-9, wherein the crystallizing comprises exposing the amorphous polycarbonate powder to a crystallization inducing solvent and the exposing results in a plurality of core-shell particles where the core of the particles comprises an amorphous domain, for example, a 90 to 100 wt % amorphous domain based on total weight of the amorphous domain and the shell of the particles comprises a crystalline domain, for example, a 10 to 60 wt % crystalline domain.

### Embodiment 11

The method of Embodiment 6, wherein crystallizing comprises exposing the amorphous polycarbonate powder to a supercritical CO₂.

### Embodiment 12

The method of Embodiment 7, wherein crystallizing comprises melt compounding the amorphous polycarbonate powder with a chemical nucleating agent to form a composition and pulverizing the composition.

### Embodiment 13

The method of Embodiment 12, wherein the nucleating agent comprises sodium o-chlorobenzoate.

### Embodiment 14

The method of any of Embodiments 7-13, wherein the amorphous polycarbonate powder comprises a first polycarbonate powder with a melt flow rate of greater than or equal to 10 g/10 min and a second polycarbonate powder with a melt flow rate of less than or equal to 8 g/10 min as determined by ASTM D1238-04 at 250° C., 1.2 kg.

### Embodiment 15

The method of any of Embodiments 6-14, wherein the compressing is performed under an inert environment and/or under vacuum.

### Embodiment 16

The method of any of Embodiments 6-15, further comprising pre-heating the crystalline powder prior to placing the crystalline polycarbonate powder in the cavity.

### Embodiment 17

The method of any of Embodiments 6-16, wherein the compression temperature is 190 to 290° C., specifically, 200 to 260° C.

### Embodiment 18

The method of any of Embodiments 6-17, wherein the crystalline polycarbonate powder has a moisture level of less than or equal to 50 ppm during the pressing.

### Embodiment 19

The method of any of Embodiments 6-18, wherein the crystallinity is 10 to 55 wt %.

### Embodiment 20

The method of any of Embodiments 6-19, wherein the crystalline polycarbonate powder comprises a bisphenol A homopolymer.

### Embodiment 21

The method of any of Embodiments 6-20, wherein the crystalline polycarbonate powder comprises a plurality of particles, wherein the plurality of particles comprise spherical particles, cylindrical particles, ovoid particles, polygonal particles, disk particles, fibrous particles, irregular particles, or a combination comprising one or more of the foregoing particles.

### Embodiment 22

The article of any of Embodiments 1-5, wherein the article is a gear, a cam, a porous filter, a flat tile, a bracket, a grill, a panel (for example, a flat panel or a curved panel), a bearing, a bush, a bearing cap, a rotor, a sprocket, a thrust plate, a pulley (for example, a timing pulley), a synchronizer hub, or a piston ring. The article can be a fuel injection component, a shock absorber component, a valve train component, or a casing (for example, of a laptop, a tablet, a smart phone, and the like).

### Embodiment 23

The article of any of Embodiments 1-5 or 22, wherein the article has one or both of a total luminous transmittance of less than or equal to 85% as measured in accordance with ASTMD1003-00, Procedure A and a haze of greater than or equal to 5%, as measured using 3.18 or 2.5 mm thick plaques according to ASTM-D1003-00.

### Embodiment 24

The article of any of the preceding embodiments, wherein the density of the article is greater than 1,200 kg/m³ as measured in accordance with ASTM D 792-13.

### Embodiment 25

The article of any of the preceding embodiments, wherein the article has a porosity of less than or equal to 5%, specifically, less than or equal to 1%, more specifically, 0%.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt %, or, more specifically, 5 to 20 wt %”, is inclusive of the endpoints and all intermediate values of the ranges of “5 to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. “Or” means “and/or.”

While particular embodiments have been described, alternatives, modifications, variations, improvements, and substantial equivalents that are or may be presently unforeseen may arise to Applicants or others skilled in the art. Accordingly, the appended claims as filed and as they may be amended are intended to embrace all such alternatives, modifications variations, improvements, and substantial equivalents.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. In addition, it is to be understood that the described elements may be combined in any suitable manner in the various embodiments.

With respect to the figures, it is noted that these figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the description for the sake of clarity, these terms are intended to refer only to the particular structure of the embodiments selected for illustration in the drawings, and are not intended to define or limit the scope of the disclosure. In the drawings and the description herein, it is to be understood that like numeric designations refer to components of like function.

Disclosure of a narrower range in addition to a broader range is not a disclaimer of the broader range. Unless defined otherwise, technical and scientific terms used herein have the same meaning as is commonly understood by one of skill in the art to which this invention belongs. “Optional” or “optionally” means that the subsequently described event or circumstance can or cannot occur, and that the description includes instances where the event occurs and instances where it does not.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to Applicants or others skilled in the art. Accordingly, the appended claims as filed and as they may be amended are intended to embrace all such alternatives, modifications variations, improvements, and substantial equivalents.

1. An article comprising a crystalline polycarbonate, wherein the article has a polycarbonate crystallinity of greater than or equal to 10 wt % based on the total weight of the crystalline polycarbonate.

2. The article of claim 1, wherein the crystalline polycarbonate has one or more of: a heat of fusion of greater than or equal to 5 J/g, a melting peak of greater than or equal to 205° C., a Vicat softening temperature of greater than or equal to 160° C.

3. The article of claim 1, wherein the article has a shortest dimension of greater than or equal to 0.2 millimeters.

4. The article of claim 1, wherein the article has an aspect ratio of a shortest dimension to a longest dimension of greater than or equal to 1:1.

5. A method of making the article of claim 1, comprising:
adding a crystalline polycarbonate powder into a cavity of a compression mold; wherein the crystalline polycarbonate powder has an average particle size of 0.5 to 4,000 micrometers and a crystallinity of greater than or equal to 10 wt % based on the total weight of the crystalline polycarbonate powder;
compressing the crystalline polycarbonate powder in the cavity at a compression temperature and at a compression pressure for a period of 1 to 30 minutes to form the article, wherein the compression temperature is greater than or equal to 10° C. less than the melting temperature of the crystalline polycarbonate powder (T_{comp}≧Tₘ−10° C.) and wherein the compression pressure is greater than or equal to 1 MPa; and
removing the article from the cavity.

6. A method of making an article, comprising:
adding a crystalline polycarbonate powder into a cavity of a compression mold; wherein the crystalline polycarbonate powder has an average particle size of 0.5 to 4,000 micrometers and a crystallinity of greater than or equal to 10 wt % based on the total weight of the crystalline polycarbonate powder;
compressing the crystalline polycarbonate powder in the cavity at a compression temperature and at a compression pressure for a period of 1 to 30 minutes to form the article, wherein the compression temperature is greater than or equal to 10° C. less than the melting temperature of the crystalline polycarbonate powder (T_{comp}≧Tₘ−10° C.) and wherein the compression pressure is greater than or equal to 1 MPa; and
removing the article from the cavity.

7. The method of claim 5, further comprising crystallizing an amorphous polycarbonate powder to form the crystalline polycarbonate powder; and drying the crystalline polycarbonate powder.

8. The method of claim 7, wherein the crystallizing comprises heating and/or exposing the amorphous polycarbonate powder to a crystallization inducing solvent.

9. The method of claim 8, wherein the solvent comprises acetone.

10. The method of claim 8, wherein the exposing results in a plurality of core-shell particles comprising a core that is an amorphous domain and a shell that is a crystalline domain.

11. The method of claim 7, wherein the crystallizing comprises exposing the amorphous polycarbonate powder to a supercritical CO₂.

12. The method of claim 7, wherein the crystallizing comprises melt compounding the amorphous polycarbonate powder with a chemical nucleating agent to form a composition and pulverizing the composition.

13. The method of claim 12, wherein the nucleating agent comprises sodium o-chlorobenzoate.

14. The method of claim 7, wherein the amorphous polycarbonate powder comprises a first polycarbonate powder with a melt flow rate of greater than or equal to 10 g/10 min and a second polycarbonate powder with a melt flow rate of less than or equal to 8 g/10 min as determined by ASTM D1238-04 at 250° C., 1.2 kg.

15. The method of claim 5, wherein the compressing is performed under an inert environment and/or under vacuum.

16. The method of claim 5, further comprising pre-heating the crystalline polycarbonate powder prior to introducing the crystalline polycarbonate powder to the cavity.

17. The method of claim 5, wherein the compression temperature is 190 to 290° C.

18. The method of claim 5, wherein the crystalline polycarbonate powder has a moisture level of less than or equal to 50 ppm during the pressing.

19. The method of claim 5, wherein the crystallinity is 10 to 55 wt %.

20. An article formed by the method of claim 6.
